(19) United States
(12) Patent Application Publication
(10) Pub. No.: US 2016/0026424 A1
(43) Pub. Date: Jan. 28, 2016

(54) DISPLAY APPARATUS AND CONTROLLING METHOD OF DISPLAY APPARATUS

(71) Applicant: AOPEN INC., New Taipei City (TW)

(72) Inventors: Chih-Hsiung Chen, New Taipei City (TW); Chao-Chi Kuan, New Taipei City (TW)

(21) Appl. No.: 14/480,639

(22) Filed: Sep. 9, 2014

(30) Foreign Application Priority Data
Jul. 22, 2014 (TW) 103125086

(51) Int. Cl. G06F 3/14; G09G 5/12

(52) U.S. Cl. CPC G06F 3/1446; G09G 5/12; G06F 3/1431; G09G 2356/00; G09G 2300/026

(57) ABSTRACT

A display apparatus including a plurality of display devices and a control system is provided. Each of the display devices has at least two sensing units. When the display devices are arranged in sequence to commonly constitute a display interface, at least one of the sensing units of each of the display devices is aligned to one of the sensing units of another one of the display devices to generate a sensing signal. The control system is electrically connected to each of the display devices. The control system determines an arranged position of each of the display devices according to each of the sensing signals, and controls a displayed image of each of the display devices according to the arranged position of each of the display devices. In addition, a controlling method of the display apparatus is also provided.

### CROSS-REFERENCE TO RELATED APPLICATION

This application claims the priority benefit of Taiwan application serial no. 103125086, filed on Jul. 22, 2014. The entirety of the above-mentioned patent application is hereby incorporated by reference herein and made a part of this specification.

### BACKGROUND OF THE INVENTION

1. Field of the Invention

The invention relates to a display apparatus and a controlling method thereof, and more particularly, relates to a display apparatus having a plurality of display devices and a controlling method thereof.

2. Description of Related Art

In this era with fast pace of life and information explosion, it is an important issue in the field of information broadcasting as how to instantly and efficiently deliver specific messages to people. Digital signages are capable of providing a large area of displayed region for multiple viewers, and have become an image display apparatus with excellent effectiveness in information broadcasting. Digital signages include a wide range of applications. For instance, in the crowded and bustling business district, digital signages may be installed as a display interface for promoting merchandises in order to draw attention from consumers. Besides, in various conference occasions, digital signages may also be used as a display interface for displaying conference information.

Particularly, in occasions of large exhibition or large conference room, a plurality of digital signages may be arranged together as a display wall, so that each of the digital signages may display a divided sub-image of a full image in order to provide the full image in large size altogether. However, in the conventional method, after the digital signages are arranged, the divided sub-images to be displayed by the digital signages must be set one by one in a manual manner, which is quite inconvenient in terms of operation.

### SUMMARY OF THE INVENTION

The invention is directed to a display apparatus capable of automatically controlling a displayed image of each of display devices according to an arrangement of the display devices.

A display apparatus of the invention includes a plurality of display devices and a control system. Each of the display devices has at least two sensing units. When the display devices are arranged in sequence to commonly constitute a display interface, at least one of the sensing units of each of the display devices is aligned to one of the sensing units of another one of the display devices to generate a sensing signal. The control system is electrically connected to each of the display devices. The control system determines an arranged position of each of the display devices according to each of the sensing signals, and controls a displayed image of each of the display devices according to the arranged position of each of the display devices.

In an embodiment of the invention, when the display devices commonly constitute the display interface, the control system controls the display devices to display different parts of a full image respectively.

In an embodiment of the invention, the control system includes a plurality of first control units, at least one second control unit and a plurality of third control units. The first control units are disposed in the display devices respectively, wherein each of the first control units is electrically connected to the corresponding two sensing units, and determines the arranged position of the corresponding display device according to the corresponding sensing signal. The second control unit divides the full image into a plurality of sub-images according to a number of the display devices, wherein the sub-images are corresponding to the arranged positions respectively. The third control units are disposed in the display devices respectively, wherein each of the third control units is electrically connected to the corresponding first control unit, and controls the corresponding display device to display the corresponding sub-image according to the arranged position of the corresponding display device.

In an embodiment of the invention, a number of the at least one second control unit is plural, and the second control units are disposed in the display devices respectively.

In an embodiment of the invention, a number of the at least one second control unit is one, and the second control unit is disposed in an external device.

In an embodiment of the invention, the external device has a first wireless transmission unit, each of the display devices has a second wireless transmission unit, and the second control unit and the third control unit transmit a wireless signal through the first wireless transmission unit and the second wireless transmission unit.

In an embodiment of the invention, the two sensing units are located at two opposite sides of the display device respectively, and at least one of the sides of each of the display devices contacts with one of the sides of another one of the display devices when the display devices are arranged in sequence.

In an embodiment of the invention, each of the display devices includes a display unit and a frame body, the display unit is installed on the frame body, and the two sensing units are disposed in the frame body.

In an embodiment of the invention, each of the display devices includes a display unit and a frame body, the display unit is installed on the frame body, and the two sensing units are disposed in the display unit.

In an embodiment of the invention, when the display devices are separated from one another, the control system controls the display devices to display a plurality of independent images respectively.

A controlling method of display apparatus of the invention of the invention includes the following steps. A display apparatus is provided, wherein the display apparatus includes a plurality of display devices and a control system, and each of the display devices has at least two sensing units. The display devices are arranged in sequence to commonly constitute a display interface, so that at least one of the sensing units of each of the display devices is aligned to one of the sensing units of another one of the display devices to generate a sensing signal. An arranged position of each of the display devices is determined by the control system according to each of the sensing signals. A displayed image of each of the display devices is controlled by the control system according to the arranged position of each of the display devices.

In an embodiment of the invention, the step of controlling the displayed image of each of the display devices includes the following steps. The display devices are controlled by the control system to display different parts of a full image respectively.

In an embodiment of the invention, the step of controlling the display devices to display the different parts of the full image respectively includes the following steps. The full image is divided into a plurality of sub-images by the control system according to a number of the display devices, wherein the sub-images are corresponding to the arranged positions respectively. The corresponding display device is controlled by the control system to display the corresponding sub-image according to the arranged position of the corresponding display device.

In an embodiment of the invention, the two sensing units are located at two opposite sides of the display device respectively, and the step of arranging the display devices in sequence includes the following steps. At least one of the sides of each of the display devices contacts with one of the sides of another one of the display devices.

In an embodiment of the invention, the controlling method further includes the following steps. When the display devices are separated from one another, the display devices are controlled by the control system to display a plurality of independent images respectively.

Based on above, the display apparatus of the invention is capable of sensing whether at least two sides of each of the display devices are adjacent to the other display devices by using the at least two sensing units of each of the display devices, such that the control system of the display apparatus may automatically determine the arranged positions of the display devices. Accordingly, after the display devices are arranged in sequence by users, the control system is capable of automatically controlling the display devices to display the corresponding divided sub-images respectively according to the arranged positions and constitute the full image in large size. Thus, users do not need to set the divided sub-images displayed by the display devices one by one in the manual manner, so as to improve convenience in use of the display apparatus.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three dimensional view of a display apparatus according to an embodiment of the invention.

FIG. 2 is a three dimensional view of the display device of FIG. 1.

FIG. 3 is a block diagram of the display apparatus of FIG. 1.

FIG. 4 is a back view of the display apparatus of FIG. 1.

FIG. 5 is a flowchart of a controlling method of display apparatus according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

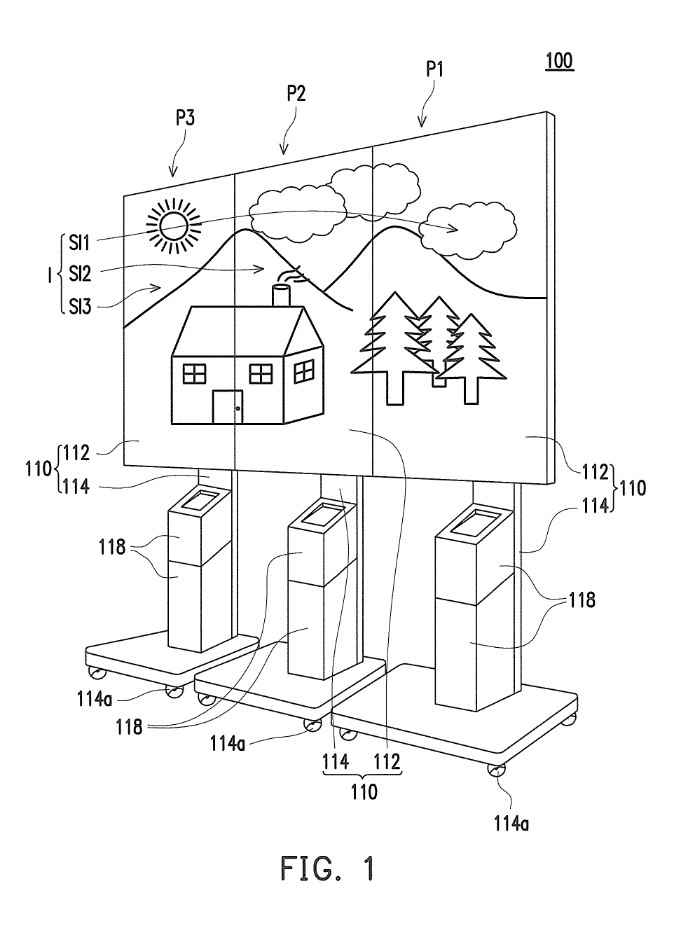

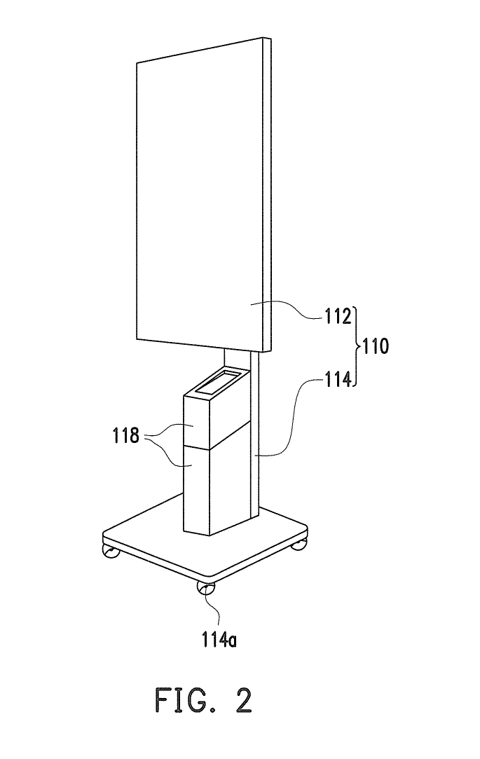

FIG. 1 is a three dimensional view of a display apparatus according to an embodiment of the invention. FIG. 2 is a three dimensional view of the display device of FIG. 1. Referring to FIG. 1 and FIG. 2, a display apparatus 100 of the present embodiment includes a plurality of display devices 110 (depicted as three). Each of the display devices 110 is, for example, a digital signage and includes a display unit 112 and a frame body 114. The display unit 112 is, for example, a flat-panel display and installed on the frame body 114. The frame body 114 includes, for example, a plurality of rollers 114a to facilitate moving each of the display devices 110. Users may arrange the display devices 110 in sequence to commonly constitute a display interface as shown in FIG. 1. The display devices 110 may also be separated from one another, so that each of the display devices 110 may be used independently as shown in FIG. 2.

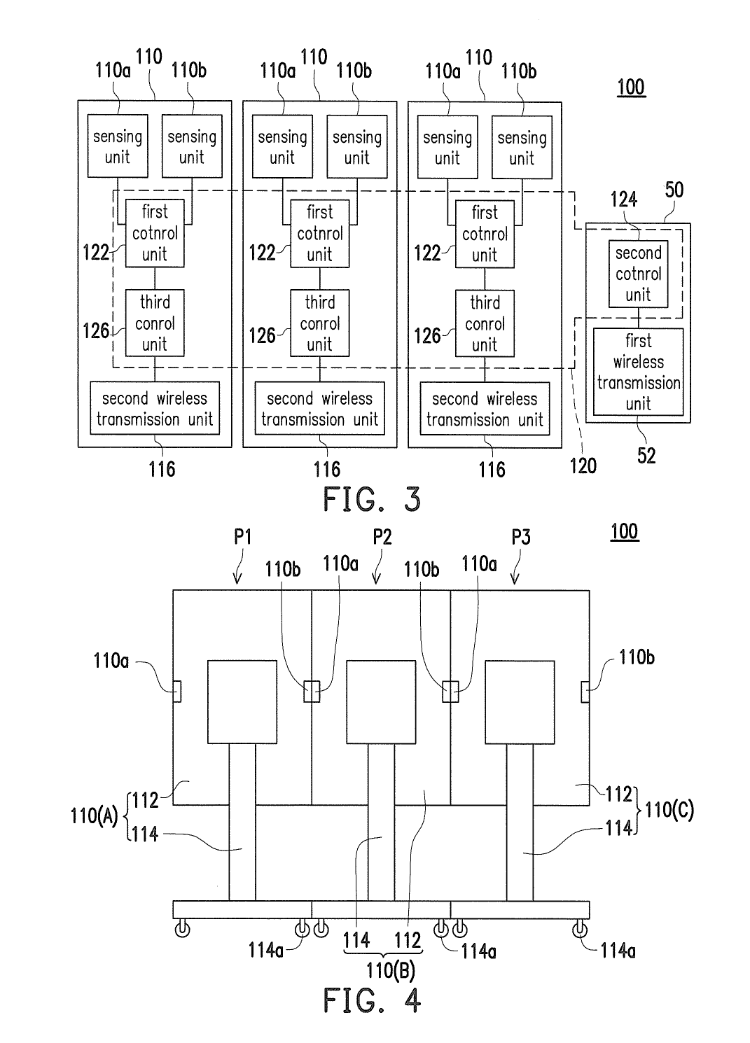

FIG. 3 is a block diagram of the display apparatus of FIG. 1. FIG. 4 is a back view of the display apparatus of FIG. 1. The display apparatus 100 of the present embodiment includes a control system 120 as shown in FIG. 3, and each of the display devices 110 has at least two sensing units as shown in FIG. 4 (depicted as two, and respectively marked as a sensing unit 110a and a sensing unit 110b). The control system 120 is electrically connected to the sensing unit 110a and the sensing unit 110b of each of the display devices 110. The sensing unit 110a and the sensing unit 110b are disposed in the display unit 112 and located at two opposite sides of the display device 110 respectively. In other embodiments, the sensing unit 110a and the sensing unit 110b may be changed to be disposed in the frame body 114, and the invention is not limited thereto.

When the display devices 110 are arranged in sequence to commonly constitute the display interface as shown in FIG. 1 and FIG. 4, at least one of the sides of each of the display devices 110 contacts with one of the sides of another one of the display devices 110, such that at least one of the sensing unit 110a and the sensing unit 110b of each of the display devices 110 is aligned to the sensing unit 110a or the sensing unit 110b of another one of the display devices 110 to generate a sensing signal. The control system 120 determines an arranged position of each of the display devices 110 according to each of the sensing signals from each of the display devices 110, and controls a displayed image of each of the display devices 110 according to the arranged position of each of the display devices 110. In the present embodiment, when the display devices 110 commonly constitute the display interface, the control system 120 controls, for example, the display devices 110 to display different parts of a full image I respectively, so as to provide the full image in large size.

Referring to FIG. 3, specifically, the control system 120 of the present embodiment includes a plurality of first control units 122 (depicted as three), at least one second control unit 124 (depicted as one) and a plurality of third control units 126 (depicted as three). The first control units 122 are, for example, micro control units (MCU), and disposed in the display units 112 of the display devices 110 respectively, wherein each of the first control units 112 is electrically connected to the corresponding sensing unit 110a and the corresponding sensing unit 110b, and determines that the arranged positions of the corresponding display devices 110 are an arranged position P1, an arranged position P2 and an arranged position P3 as shown in FIG. 1 and FIG. 4 according to the corresponding sensing signals. The second control unit 124 divides the full image I (marked in FIG. 1) into a plurality of sub-images SI1, SI2 and SI3 (marked in FIG. 1) according to a number of the display devices 110, wherein the sub-images SI1, SI2 and SI3 are corresponding to the arranged positions P1, P2 and P3 respectively. The third control units 126 are, for example, a mother board disposed in each of the display units 112 respectively, wherein each of the third control units 126 is electrically connected to the corresponding first control unit 122, and controls the corresponding display device 110 to display the corresponding sub-image (SI1, SI2 or SI3) according to the arranged position (P1, P2 or P3) of the corresponding display device 110.

In order to clarify the drawing and the description, in FIG. 4, the display device located at the arranged position P1 is marked as a display device 110(A); the display device located at the arranged position P2 is marked as a display device 110(B); and the display device located at the arranged position P3 is marked as a display device 110(C). Specifically, in the arrangement shown in FIG. 4, the sensing unit 110a of the display device 110(A) is not aligned to any sensing unit of the other display devices 110, so that the sensing signal is not generated; and the sensing unit 110b of the display device 110(A) is aligned to the sensing unit 110a of the display device 110(B) to generate the sensing signal. Thus, the control system 120 is capable of determining that the display device 110(A) is located at the arranged position P1 according to the sensing signal generated by the sensing unit 110b of the display device 110(A).

As mentioned above, the sensing unit 110a of the display device 110(B) is aligned to the sensing unit 110b of display device 110(A) to generate the sensing signal; and the sensing unit 110b of the display device 110(B) is aligned to the sensing unit 110a of the display device 110(C) to generate the sensing signal. Thus, the control system 120 is capable of determining that the display device 110(B) is located at the arranged position P2 according to the sensing signal generated by the sensing unit 110a of the display device 110(B) and the sensing signal generated by the sensing unit 110b of the display device 110(B).

As mentioned above, the sensing unit 110a of the display device 110(C) is aligned to the sensing unit 110b of display device 110(B) to generate the sensing signal; and the sensing unit 110b of the display device 110(C) is not aligned to any sensing unit of the other display devices, so that the sensing signal is not generated. Thus, the control system 120 is capable of determining that the display device 110(C) is located at the arranged position P3 according to the sensing signal generated by the sensing unit 110a of the display device 110(C).

Based on the disposition and the controlling method as described above, the display apparatus 100 of the present embodiment is capable of sensing whether the opposite two sides of each of the display devices 110 are adjacent to the other display devices 110 by using the sensing unit 110a and the sensing unit 110b of each of the display devices 110, such that the control system 120 of the display apparatus 100 may automatically determine the arranged positions of the display devices 110. Accordingly, after the display devices 110 are arranged in sequence by users, the control system 120 is capable of automatically controlling the display devices 110 to display the corresponding divided sub-images respectively according to the arranged positions and constitute the full image in large size. Thus, users do not need to set the divided sub-images displayed by the display devices 110 one by one in the manual manner, so as to improve convenience in use of the display apparatus 100. When users no longer need to use the display devices 110 for providing the full image in large size, the display devices 110 may be separated from one another. In this case, the control system 120 is capable of controlling the display devices 110 to display a plurality of independent images respectively. Because the display devices 110 include a function of independently displaying the images in smaller size and commonly displaying the image in larger size as described above, users do not need to repeatedly purchase the display apparatus for displaying images in different sizes, so as to save procurement costs.

In the present embodiment, the sensing unit 110a and the sensing unit 110b are, for example, a supersonic sensor, an infrared sensor, a magnetic reed switch, an inching switch or other suitable sensors, but the invention is not limited thereto.

Referring to FIG. 3, the second control unit 124 of the present embodiment is, for example, a control circuit disposed in an external device 50, and adapted to divide the full image I (marked in FIG. 1) into the sub-images SI1, SI2 and SI3 (marked in FIG. 1) by using an image segmentation software of the external device 50. The external device 50 is, for example, a computer that has a first wireless transmission unit 52. Each of the display devices 110 has a second wireless transmission unit 116. The second control unit 124 and each of the third control units 126 transmit a wireless signal through the first wireless transmission unit 52 and the second wireless transmission unit 116, such that the second control unit 124 is capable of obtaining information of a number of the display devices 110 for determining the number of the sub-images to be divided. The first wireless transmission unit 52 and the second wireless transmission unit 116 are, for example, a WiFi communication module or other suitable wireless transmission units, and the second control unit 124 and each of the third control units 126 may also transmit information in a wired manner, but the invention is not limited thereto.

In the present embodiment, the second control unit 124 transmits information regarding the sub-images SI1, SI2 and SI3 to each of the third control units 126 by using, for example, a transmission interface of Digital Video Broadcasting-Terrestrial (DVB-T), so that each of the display devices 110 is capable of displaying images with higher quality. In other embodiments, the information regarding the sub-images SI1, SI2 and SI3 may also be transmitted through the first wireless transmission unit 52 and the second wireless transmission unit 116, and the invention is not limited thereto.

Furthermore, a number of the second control unit 124 and a disposing method thereof are not particularly limited in the invention either. For instance, the number of the second control unit 124 may be plural, and these second control units 124 may be disposed in a housing 118 (shown in FIG. 1) of the display device 110. In addition, an uninterruptible power supply (UPS) may also be disposed in the housing 118 of the display device 110, so that the display device 110 is capable of operating continuously without connecting to an external power supply to thereby facilitate moving the display device 110.

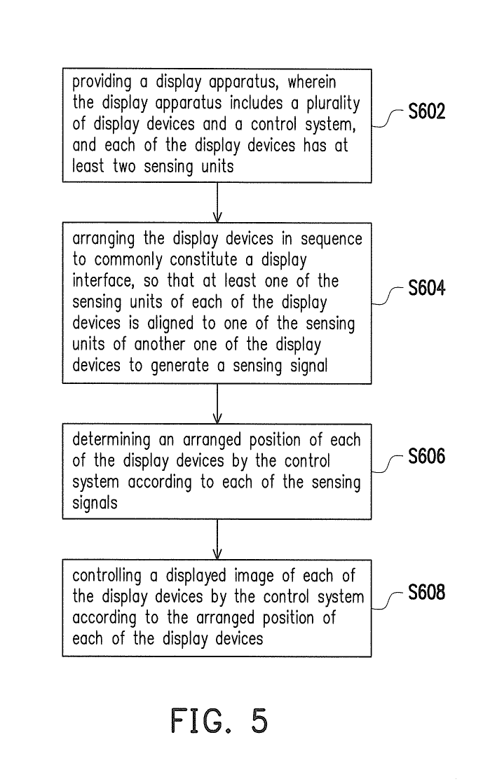

An example is provided below by using aforesaid display apparatus 100 to describe a controlling method of display apparatus of the invention. FIG. 5 is a flowchart of a controlling method of display apparatus according to an embodiment of the invention. Referring to FIG. 3 to FIG. 5, a display apparatus 100 is provided, wherein the display apparatus 100 includes a plurality of display devices 110 and a control system 120, and each of the display devices 110 has at least two sensing units 110a and 110b (step S602). The display devices 110 are arranged in sequence to commonly constitute a display interface, so that at least one of the sensing units (110a or 110b) of each of the display devices 110 is aligned to one of the sensing units (110a or 110b) of another one of the display devices 110 to generate a sensing signal (step S604).

An arranged position of each of the display devices 110 is determined by the control system 120 according to each of the sensing signals (step S606). A displayed image of each of the display devices 110 is controlled by the control system 120 according to the arranged position of each of the display devices 110 (step S608).

In summary, the display apparatus of the invention is capable of sensing whether at least two sides of each of the display devices are adjacent to the other display devices by using the at least two sensing units of each of the display devices, such that the control system of the display apparatus may automatically determine the arranged positions of the display devices. Accordingly, after the display devices are arranged in sequence by users, the control system is capable of automatically controlling the display devices to display the corresponding divided sub-images respectively according to the arranged positions and constitute the full image in large size. Thus, users do not need to set the divided sub-images displayed by the display devices one by one in the manual manner, so as to improve convenience in use of the display apparatus. Because the display devices include a function of independently displaying the images in smaller size and commonly displaying the image in larger size as described above, users do not need to repeatedly purchase the display apparatus for displaying images in different sizes, so as to save procurement costs.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A display apparatus, comprising:
a plurality of display devices, each of the display devices having at least two sensing units, and at least one of the sensing units of each of the display devices being aligned to one of the sensing units of another one of the display devices to generate a sensing signal when the display devices are arranged in sequence to commonly constitute a display interface; and
a control system, electrically connected to each of the display devices, wherein the control system determines an arranged position of each of the display devices according to each of the sensing signals, and controls a displayed image of each of the display devices according to the arranged position of each of the display devices.

2. The display apparatus of claim 1, wherein when the display devices commonly constitute the display interface, the control system controls the display devices to display different parts of a full image respectively.

3. The display apparatus of claim 2, wherein the control system comprises:
a plurality of first control units, disposed in the display devices respectively, wherein each of the first control units is electrically connected to the corresponding two sensing units, and determines the arranged position of the corresponding display device according to the corresponding sensing signal;
at least one second control unit, dividing the full image into a plurality of sub-images according to a number of the display devices, wherein the sub-images are corresponding to the arranged positions respectively; and
a plurality of third control units, disposed in the display devices respectively, wherein each of the third control units is electrically connected to the corresponding first control unit, and controls the corresponding display device to display the corresponding sub-image according to the arranged position of the corresponding display device.

4. The display apparatus of claim 3, wherein a number of the at least one second control unit is plural, and the second control units are disposed in the display devices respectively.

5. The display apparatus of claim 3, wherein a number of the at least one second control unit is one, and the second control unit is disposed in an external device.

6. The display apparatus of claim 5, wherein the external device has a first wireless transmission unit, each of the display devices has a second wireless transmission unit, and the second control unit and the third control unit transmit a wireless signal through the first wireless transmission unit and the second wireless transmission unit.

7. The display apparatus of claim 1, wherein the two sensing units are located at two opposite sides of the display device respectively, and at least one of the sides of each of the display devices contacts with one of the sides of another one of the display devices when the display devices are arranged in sequence.

8. The display apparatus of claim 1, wherein each of the display devices comprises a display unit and a frame body, the display unit is installed on the frame body, and the two sensing units are disposed in the frame body.

9. The display apparatus of claim 1, wherein each of the display devices comprises a display unit and a frame body, the display unit is installed on the frame body, and the two sensing units are disposed in the display unit.

10. The display apparatus of claim 1, wherein when the display devices are separated from one another, the control system controls the display devices to display a plurality of independent images respectively.

11. A controlling method of display apparatus, comprising:
providing a display apparatus, wherein the display apparatus comprises a plurality of display devices and a control system, and each of the display devices has at least two sensing units;
arranging the display devices in sequence to commonly constitute a display interface, so that at least one of the sensing units of each of the display devices is aligned to one of the sensing units of another one of the display devices to generate a sensing signal;
determining an arranged position of each of the display devices by the control system according to each of the sensing signals; and
controlling a displayed image of each of the display devices by the control system according to the arranged position of each of the display devices.

12. The controlling method of claim 11, wherein the step of controlling the displayed image of each of the display devices comprises:
controlling the display devices by the control system to display different parts of a full image respectively.

13. The controlling method of claim 12, wherein the step of controlling the display devices to display the different parts of the full image respectively comprises:
dividing the full image into a plurality of sub-images by the control system according to a number of the display devices, wherein the sub-images are corresponding to the arranged positions respectively; and
controlling the corresponding display device by the control system to display the corresponding sub-image according to the arranged position of the corresponding display device.

14. The controlling method of claim 11, wherein the two sensing units are located at two opposite sides of the display device respectively, and the step of arranging the display devices in sequence comprises:
making at least one of the sides of each of the display devices contact with one of the sides of another one of the display devices.

15. The controlling method of claim 11, further comprising:
when the display devices are separated from one another, controlling the display devices by the control system to display a plurality of independent images respectively.
